(19) United States
(12) Patent Application Publication
(10) Pub. No.: US 2010/0153934 A1
(43) Pub. Date: Jun. 17, 2010

(54) Prefetch for systems with heterogeneous architectures

(76) Inventor: Peter Lachner, Heroldstatt (DE)

Correspondence Address: INTEL CORPORATION;c/o CPA Global, P.O. BOX 52050, MINNEAPOLIS, MN, 55402, US

(21) Appl. No.: 12/316,585

(22) Filed: Dec. 12, 2008

(51) Int. Cl. G06F 9/45; G06F 15/76

(52) U.S. Cl. 717/146; 712/28; 717/151; 712/E09.045

(57) ABSTRACT

A compiler for a heterogeneous system that includes both one or more primary processors and one or more parallel co-processors is presented. For at least one embodiment, the primary processors(s) include a CPU and the parallel co-processor(s) include a GPU. Source code for the heterogeneous system may include code to be performed on the CPU but also code segments, referred to as “foreign macro-instructions”, that are to be performed on the GPU. An optimizing compiler for the heterogeneous system comprehends the architecture of both processors, and generates an optimized fat binary that includes machine code instructions for both the primary processor(s) and the co-processor(s). The optimizing compiler compiles the foreign macro-instructions as if they were predefined functions of the CPU, rather than as remote procedure calls. The binary is the result of compiler optimization techniques, and includes prefetch instructions to load code and/or data into the GPU memory concurrently with execution of other instructions on the CPU. Other embodiments are described and claimed.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### TECHNICAL FIELD

The present disclosure relates generally to compilation of computation tasks for heterogeneous multiprocessor systems.

### BACKGROUND

A compiler translates a computer program written in a high-level language, such as C++, DirectX, or FORTRAN, into machine language. The compiler takes the high-level code for the computer program as input and generates a machine executable binary file that includes machine language instructions for the target hardware of the processing system on which the computer program is to be executed.

The compiler may include logic to generate instructions to perform software-based prefetching. Software prefetching masks memory access latency by issuing a memory request before the requested value is used. While the value is retrieved from memory—which can take up to 300 or more cycles—the processor can execute other instructions, effectively hiding the memory access latency.

A heterogeneous multi-processor system may include one or more general purpose central processing units (CPUs) as well as one or more of the following additional processing elements: specialized accelerators, digital signal processor(s) (“DSPs”), graphics processing unit(s) (“GPUs”) and/or reconfigurable logic element(s) (such as field programmable gate arrays, or FPGAs).

In some known systems, the coupling of the general purpose CPU with the additional processing element(s) is a “loose” coupling within the computing system. That is, the integration of the system is on a platform level only, such that the software and compiler for the CPU is developed independently from the software and compiler for the additional processing element(s). Typically, the programming model and methodology for the CPU and the additional processing element(s) are quite distinct. Different programming models, such as C++ vs. DirectX may be used, as well as different development tools from different vendors, different programming languages, etc.

In such cases, communication between the various software components of the system may be performed via heavyweight hardware and software mechanisms using special hardware infrastructure such as, e.g., PCIe bus and/or OS support via device drivers. Such approach is challenged and presents limitations when it is desired, from an application development point of view, to treat the CPU and one or more of the additional processing element(s) as one integrated processor entity (e.g., tightly coupled co-processors) for which a single computer program is to be developed. Such approach is sometimes referred to as a “heterogeneous programming model”.

### BRIEF DESCRIPTION OF THE DRAWINGS

FIG. 1 is a block data-flow diagram illustrating at least one embodiment of a system to provide compiler prefetch optimizations for a heterogeneous multi-processor system.

FIG. 2 is a block diagram illustrating selected elements of at least one embodiment of a heterogeneous multiprocessor system.

FIG. 3 is a dataflow diagram illustrating at least one embodiment of compiler operations for a set of instructions in a pseudo-code example.

FIG. 4 is a flowchart illustrating at least one embodiment of a method for compiling a foreign code sequence.

FIG. 5 is a block diagram of a system in accordance with at least one embodiment of the present invention.

FIG. 6 is a block diagram of a system in accordance with at least one other embodiment of the present invention.

FIG. 7 is a block diagram of a system in accordance with at least one other embodiment of the present invention.

FIG. 8 is a block diagram illustrating pseudo-code created as a result of compilation of a foreign pseudo-code sequence according to at least one embodiment of the invention.

FIG. 9 is a block data flow diagram illustrating at least one embodiment of elements of a first and second processor domain to execute code compiled according to at least one embodiment of a heterogeneous programming model.

### DETAILED DESCRIPTION

Embodiments provide a compiler for a heterogeneous programming model for a heterogeneous multi-processor system. A compiler generates machine code that includes prefetching and/or scheduling optimizations for code to be executed on a first processing element (such as, e.g., a CPU) and one or more additional processing element(s) (such as, e.g., GPU) of a heterogeneous multi-processor system. Although presented below in the context of heterogeneous multi-processor systems, the apparatus, system and method embodiments described herein may be utilized with homogenous or asymmetric multi-core systems as well.

Although specific sample embodiments presented herein are presented in the context of a computing system having one or more CPUs and one or more graphics co-processors, such illustrative embodiments should not be taken to be limiting. Alternative embodiments may include other additional processing elements instead of, or in addition to, graphics co-processors (also sometimes referred to herein as “GPUs”). Such other additional processing elements may include any processing element that can execute a stream of instructions (such as, for example, a computation engine, a digital signal processor, acceleration co-processor, etc).

In the following description, numerous specific details such as system configurations, particular order of operations for method processing, specific examples of heterogeneous systems, pseudo-code examples of source code and compiled code, and implementation details for embodiments of compilers and library routines have been set forth to provide a more thorough understanding of embodiments of the present invention. It will be appreciated, however, by one skilled in the art that the invention may be practiced without such specific details. Additionally, some well-known structures, circuits, and the like have not been shown in detail to avoid unnecessarily obscuring the present invention

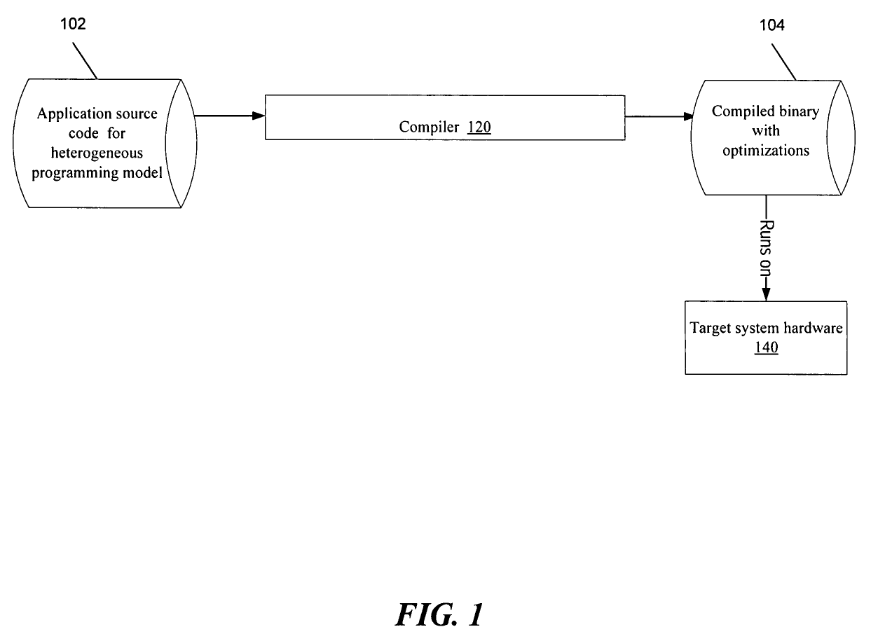

FIG. 1 illustrates at least one embodiment of a compiler 120 to generate compiler-based software pre-fetch optimization instructions for code to be executed on a heterogeneous multi-processor target hardware system 140. For at least one embodiment, the compiler translates a computer program 102 written in a high-level language, such as C++, DirectX, or FORTRAN, into machine language for the appropriate processing elements of the target hardware system 140. The compiler takes the high-level code for the computer program as input and generates a so-called “fat” machine executable binary file 104 that includes machine language instructions for both a first and second processing element of the target hardware of the processing system on which the computer program is to be executed. For at least one embodiment, the resultant “fat” binary file 104 includes machine language instructions for a first processing element (e.g., a CPU) and a second processing element (e.g., a GPU). Such machine language instructions are generated by the compiler 120 without aid of library routines. That is, the compiler 120 comprehends the native instruction sets of both the first and second processing elements, which are heterogeneous with respect to each other.

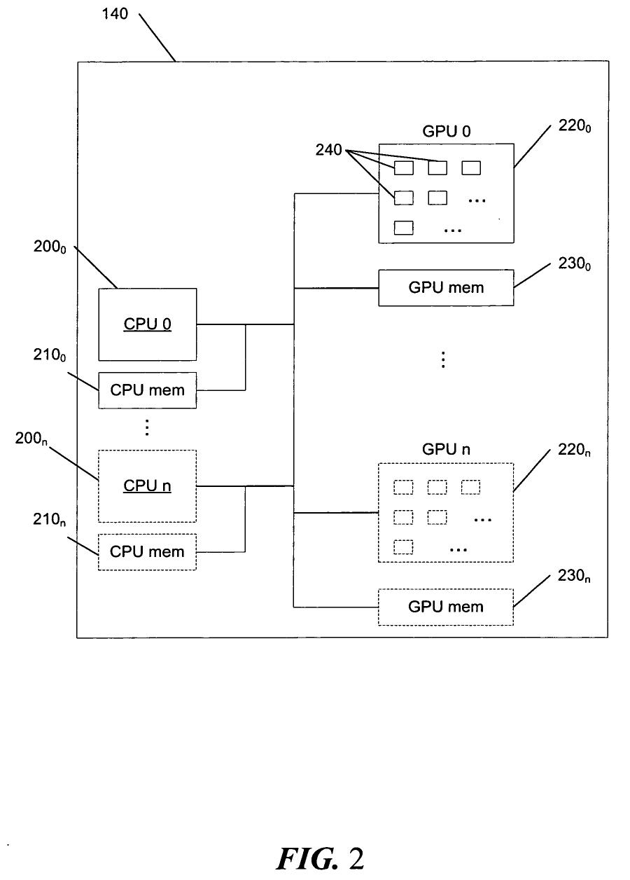

FIG. 2 illustrates at least one embodiment of the target hardware system 140. While certain features of the system 140 are illustrated in FIG. 2, one of skill in the art will recognize that the system 140 may include other components that are not illustrated in FIG. 2. FIG. 2 should not be taken to be limiting in this regard; certain components of the hardware system 140 have been intentionally omitted so as not to obscure the components under discussion herein.

FIG. 2 illustrates that that the target hardware system 140 may include multiple processing units. The processing units of the target hardware system 140 may include one or more general purpose processing units 200₀-200ₙ, such as, e.g., central processing units (“CPUs”). For embodiments that optionally include multiple general purpose processing units 200, additional such units (200₁-200ₙ) are denoted in FIG. 2 with broken lines.

The general purpose processors 200₀-200ₙ of the target hardware system 140 may include multiple homogenous processors having the same instruction set architecture (ISA) and functionality. Each of the processors 200 may include one or more processor cores.

For at least one other embodiment, however, at least one of the CPU processing units 200₀-200ₙ may be heterogeneous with respect to one or more of the other CPU processing units 200₀-200ₙ of the target hardware system 140. For such embodiment, the processor cores 200 of the target hardware system 140 may vary from one another in terms of ISA, functionality, performance, energy efficiency, architectural design, size, footprint or other design or performance metrics. For at least one other embodiment, the processor cores 200 of the target hardware system 140 may have the same ISA but may vary from one another in other design or functionality aspects, such as cache size or clock speed.

Other processing unit(s) 220 of the target hardware system 140 may feature ISAs and functionality that significantly differ from general purpose processing units 200. These other processing units 220 may optionally include, as shown in FIG. 2, multiple processor cores 240.

For one example embodiment, which in no way should be taken to be an exclusive or exhaustive example, the target hardware system 140 may include one or more general purpose central processing units (“CPUs”) 200₀-200ₙ along with one or more graphics processing unit(s) (“GPUs”), 220₀-220ₙ. Again, for embodiments that optionally include multiple GPUs, additional such units 220₁-220ₙ are denoted in FIG. 2 with broken lines.

As indicated above, the target hardware system 140 may include various types of additional processing elements 220 and is not limited to GPUs. Any additional processing element 220 that has characteristics of high parallel computing capabilities (such as, for example, a computation engine, a digital signal processor, acceleration co-processor, etc) may be included, in addition to the one or more CPUs 200₀-200ₙ of the target hardware system 140. For instance, at least one other example embodiment the target hardware system 140 may include one or more reconfigurable logic elements 220, such as a field programmable gate array. Other types of processing units and/or logic elements 220 may also be included for embodiments of the target hardware system 140.

FIG. 2 further illustrates that the target hardware system 140 includes memory storage elements 210₀-210ₙ, 230₀-230ₙ. FIG. 2 illustrates memory storage elements 210h₀-210ₙ, 230₀-230ₙ that are logically associated with each of the processing elements 200₀-220ₙ, 220₀-220ₙ, respectively.

The memory storage elements 210₀-210ₙ, 230₀-230ₙ may be implemented in any known manner. One or more of the elements 210₀-210ₙ, 230₀-230ₙ may, for example, be implemented as a memory hierarchy that includes one or more levels of on-chip cache as well as off-chip memory. Also, one of skill in the art will recognize that the illustrated memory storage elements 210₀-210ₙ, 230₀-230ₙ, though illustrated as separate elements, may be implemented as logically partitioned portions of one or more shared physical memory storage elements.

It should be noted, however, that whatever the physical implementation, it is anticipated for at least one embodiment that the memory storage elements 210 of the one or more CPUs 200 are not shared by the GPUs (see, e.g., GPU memory 230). For such embodiment, the CPU 200 and GPU 220 processing elements do not share virtual memory address space. (See further discussion below of the transport layer 904 for the transfer of code and data between CPU memory 210 and GPU memory 230.)

For an application development approach that employs a heterogeneous programming model, the various processing elements 200₀-220ₙ, 220₀-220ₙ of the target hardware system 140 may be treated as one “super-processor”, with the GPUs 230₀-230ₙ viewed as co-processors for the one or more CPUS 200₀-220ₙ of the system 140.

Traditionally, a compiler may invoke GPU-type functions through a GPU library that includes routines with support for moving data into and out of the GPU, which are optimized for the architecture of the target hardware system 140. For example, software developers may write library functions that are optimized for the underlying hardware of a GPU co-processor 220. These library functions may include code for complex tasks such as highly complex matrix multiplication that multiplies 10 K×10 K elements, MPEG-3 decoder for audio streaming, etc. The library code is optimized for the architecture of the GPU co-processor on which it is to be executed. Thus, when a compiled application program is executed on CPU 200 of such a “super-processor” 140, the compiled code includes a function call to the appropriate library function, thereby “offloading” execution of the complex processing task to the GPU co-processor 220.

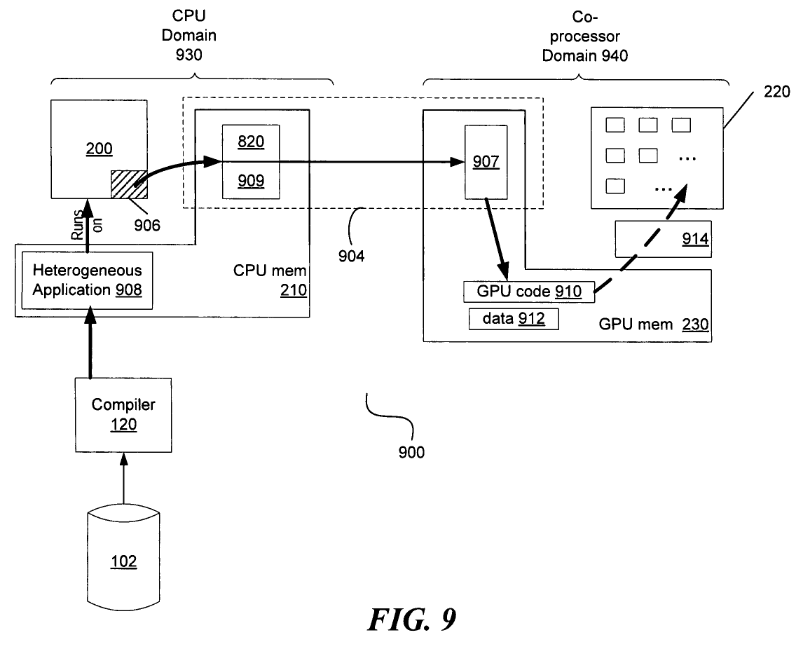

A cost associated with this traditional library-based compilation approach is the latency associated with transferring the data for these complex calculations from the CPU domain (e.g., 930 of FIG. 9) into the GPU domain (e.g., 940 of FIG. 9). Consider, for example, a 10 K by 10 K matrix multiplication operation. There may be significant time latency involved with communicating data for these complex tasks from one processing element 200 (e.g., a CPU running Windows OS) to another processing element 220 (e.g., GPU co-processor on an extension card) of a target hardware system 140. The total latency for this matrix multiplication task is (time it takes the GPU to perform this complex computation) PLUS (time it takes to transport the necessary data to and from the GPU). The computation time therefore includes waiting for all of the data to get to the GPU. This wait time may be significant, especially in systems that utilize PCIe bus or other heavyweight hardware infrastructure to support communication between processing elements 200, 220 of the system,

For embodiments of the compiler 120 illustrated in FIG. 1, these foreign code sequences are not compiled as library calls. Instead, they are compiled as if they are very complex native ‘instructions’ (referred to herein as “foreign macro-instructions”) of the CPU 220 itself. This allows the compiler 120 (FIG. 1) to employ instruction scheduling optimization techniques to alleviate the latency problem discussed above. That is, the compiler 120 can treat the foreign macro-instructions as long-latency native instructions with long, unpredictable cycle times. For at least one embodiment, optimization techniques employed by the compiler 120 for such instructions may include software prefetching techniques.

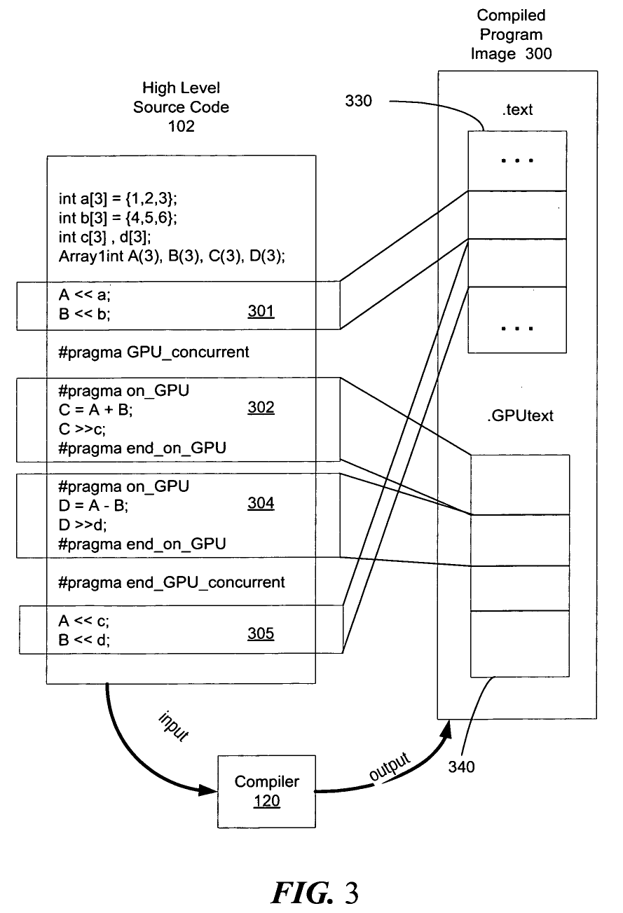

The compiler can use these techniques to perform latency scheduling optimizations. That is, scheduling can be accomplished by judiciously placing the prefetch instructions into the code stream. In this manner, the compiler can order the process of the instructions in order to allow the CPU to continue processing during the latency associated with loading data or instructions from the CPU to the GPU. One of skill in the art will recognize that this latency avoidance is desirable because the time required to retrieve data from memory is much greater than execution time of a processing unit. For example, an Add or Multiply instruction may take a processing unit only 1-2 cycles to execute, and it may take the processing unit only 1 cycle to retrieve data on a cache hit. But, to retrieve data into memory of the GPU from the CPU or retrieve the results back to the CPU from the GPU may take about 300 cycles. Thus, during the time it takes to load data or instructions into the GPU memory, the CPU could otherwise have performed 300 computations. To alleviate this latency problem, the compiler (e.g., 120 of FIGS. 1 and 3) may perform prefetching, a type of optimization technology in which the compiler inserts prefetch instructions into the compiled code (e.g., 104 of FIG. 1) that attempt to ensure that data and code are already in the memory when it is needed by a processing element.

A compiler is to compile code written in a particular high-level programming language, such as FORTRAN, C, C++, etc. The compiler is expected to correctly recognize and compile any instructions that are defined in the programming language definition. Any function that is defined by the language specification is referred to as a “predefined” function. An example of a predefined function defined for many high-level programming languages is the cosine function. For this function, when the programmer includes the function in the high-level code, the compiler for the high-level programming language understands exactly how the function the function signature, and what the function should do. That is, for predefined functions for a particular programming language, the language specification describes in detail the spelling and functionality of the function, and the compiler recognizes this and relies on this information. The language specification also defines the data type of the output of the function, so the programmer need not declare the output type for the function in the high-level code. The standard also defines the data types for the input arguments, and the compiler will automatically flag an error if the programmer has provided an argument of the wrong type. A predefined function will be spelled the same way and work the same way on any standard-conforming compiler for the particular programming language. The compiler may, for example, have an internal table to tell it the correct return types or argument types for the predefined function.

In contrast, a traditional compiler does not have this type of internal information for functions that are not predefined for the particular programming language being used and are, instead, calls to a library function. This type of library function call may be referred to herein as a general purpose library call. For such library function calls, the compiler has no internal table to tell it the correct return types or argument types for the function, nor the correct spelling of the function. In such case, it is up to the programmer to declare the function of the correct type, and to provide arguments of the correct type. As a result, programmer errors for these data types will not be caught by the compiler at compile-time. Also as a result, prefetching optimizations are not performed by the compiler for such general purpose library function calls.

We refer briefly back to FIG. 1. In order to perform prefetching for a processing unit, such as GPU, in a heterogeneous multi-processor system, at least some embodiments of the present include a modified compiler 120. The compiler 120 compiles a GPU function, which would typically be compiled as a general purpose library call in a traditional compiler, as one or more run-time support functions, such as a “launch” function. This approach allows the compiler 120 to insert an instruction to begin pre-fetch for the GPU operation well before execution of the “launch” function. By compiling the GPU function as a native CPU instruction, rather than as a general purpose library call, the compiler 120 can treat it like a regular long-latency instruction and can then employ pre-fetching optimization for the instruction.

In order to achieve this desired result, certain modifications are made to the compiler 120 for one or more embodiments of the present invention. For predefined functions that are to be executed on a CPU, the compiler is aware that a function has an in and out data set. For these predefined functions, the compiler has innate knowledge of the function and can optimize for it. Such predefined functions are treated by the compiler differently from a “general purpose” functions. Because the compiler knows more about the predefined function, the compiler can take that information into account for scheduling and prefetch optimizations during compilation.

The modified compiler 120 takes function calls that might ordinarily be compiled as general purpose library calls for the GPU, and instead treats them like native CPU instructions (so-called “foreign macro instructions”) in terms of scheduling and optimizations that the compiler 120 performs. Thus, the compiler 120 illustrated in FIG. 1 may utilize scheduling and pre-fetch techniques to overcome latency impacts associated with tasks off-loaded to a co-processor or other computation processing elements. That is, the compiler 120 has been modified so that it can effectively offload from a CPU 200 foreign code portions to a GPU 220 by treating the code portions as foreign macro-instructions and utilizing for such foreign macro-instructions scheduling and prefetch optimization techniques.

FIG. 3 illustrates a compiler 120 that compiles foreign code sequences as foreign macro-instructions rather than treating them as general purpose function calls to a runtime library. The compiler 120 effectively offloads from the CPU foreign code portions to a GPU by treating them as foreign macro-instructions that can then be subjected to compiler-based optimization techniques.

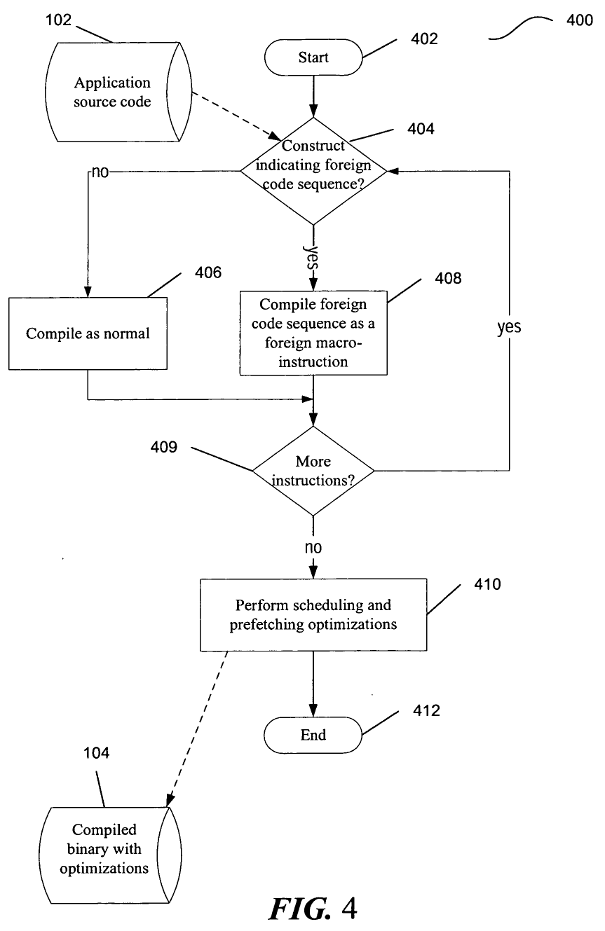

FIG. 3 illustrates that the programmer may indicate via a special high-level language construct, such as a pragma, that certain code is to be off-loaded for execution to the GPU. A pragma is a compiler directive via which the programmer can provide information to the compiler. For the pseudocode example shown in FIG. 3, the “#pragma” statements are used by the programmer to indicate to the compiler that certain sections of the source code 102 are to be treated as “foreign code’ that is to be compiled as foreign macro-instructions and offloaded during runtime for execution on the GPU. In FIG. 4, the pseudocode portion 302 between the “#pragma on_GPU” and “#pragma end_on_GPU” is a “foreign macro-instruction” to be performed on the GPU rather than the CPU. Similarly, code section 304 is also a “foreign macro-instruction” to be performed on the GPU. Furthermore, the foreign macro-instructions 302, 304 between the “#pragmaGPU_concurrent” and “#pragma CPU_concurrent_end” statements are to be executed concurrently with each other on separate thread units (either separate physical processor cores or on separate logical processors of the same multithreaded core) of the GPU.

The compiler 120, which has been modified to support a heterogeneous compilation model, creates both the CPU machine code stream 330 and GPU machine code stream 340 into one combined “fat” program image 300. The combined program image 300 includes at least two segments: the segment 330 that includes the compiled code for the regular native CPU code sequences (see, e.g., 301 and 305) and the segment 340 that includes the compiled code for the “foreign” macro-instruction sequences (see, e.g., 302 and 304).

The foreign code sequences are treated by the compiler as if they are extensions to the instruction set of the CPU, so-called “foreign macro-instructions”. Accordingly, the compiler 120 may perform prefetch optimizations for the foreign macro-instructions that would not have been possible if the compiler had compiled the foreign code sequences as general purpose library function calls.

FIG. 4 is a flowchart of a method 400 to compile source code having foreign code sequences into compiled code that includes prefetching and scheduling optimizations for the foreign code sequences. For at least one embodiment, the method 400 may be performed by a compiler (see, e.g., 120 of FIG. 1) that has been modified to support a heterogeneous programming model by 1) compiling foreign code sequences as foreign macro-instructions that are extensions of the native instruction set of a CPU and 2) generating pre-fetch-optimized machine code for both the CPU and GPU in one executable file.

FIG. 4 illustrates that the method 400 begins at block 402 and proceeds to Block 404. At block 404, it is determined whether the next high-level instruction of source code 102 under compilation is a construct (such as a pragma or other type of compiler directive) indicating that the code should be compiled for a co-processor. If so, processing proceeds to block 408; otherwise, processing proceeds to block 406. At block 406, the instruction undergoes normal compiler processing.

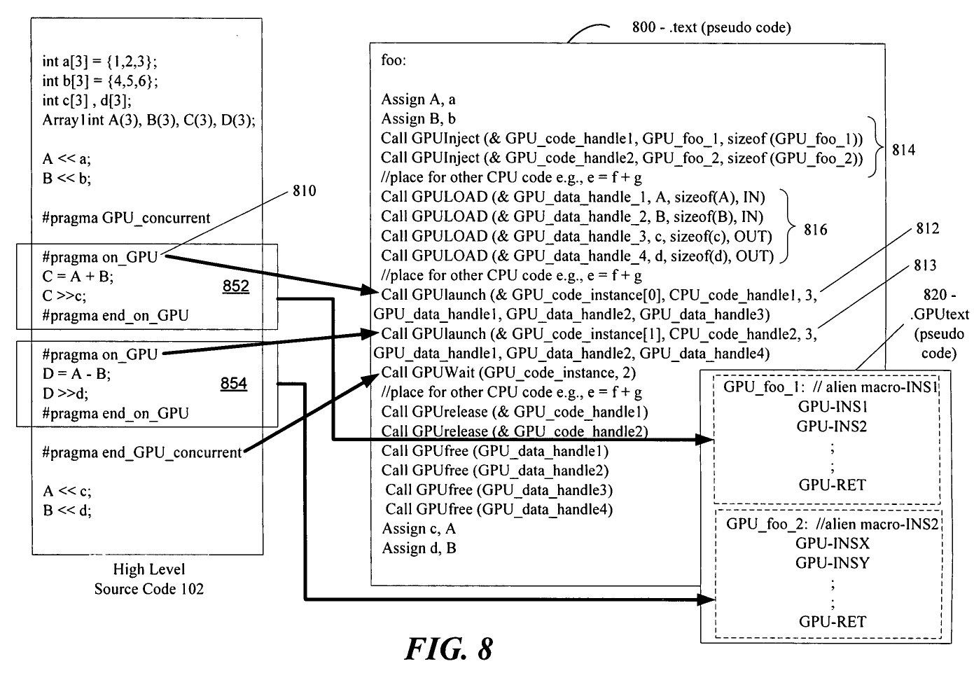

At block 408, however, special processing takes place for the foreign code. Responsive to the pragma or other compiler directive, the foreign code is compiled as a foreign macro-instruction. (The processing of block 408 is discussed in further detail below in connection with FIG. 8.)

From blocks 406 and 408, processing proceeds to block 409. If there are more high-level instructions from the source code 102 to be compiled, processing returns to block 404; otherwise, processing proceeds to block 410.

At block 410, the compiler performs scheduling and/or prefetch optimizations on the code that contains the foreign macro-instructions. The result of block 410 processing is the generation of a single program image 104 similar to the image 300 of FIG. 3, but which has been optimized with prefetch instructions for the GPU. Processing then ends at block 412.

Turning to FIG. 8, the processing of at least one embodiment of block 408 (FIG. 4) is illustrated in further detail. FIG. 8 illustrates two foreign macro-instructions 852, 854 and shows the run-time support functions that are generated for the CPU portion 800 of the compiled code when the source code 102 that contains the foreign macro-instructions is compiled by the modified compiler 120 illustrated in FIGS. 1 and 3. These run-time support functions include GPUInject( ), GPUload( ), GPUlaunch( ), GPUwait( ), GPU release( ), and GPUfree( ). One of skill in the art will recognize that such support function names are provided for illustration only and should not be taken to be limiting. In addition, additional or other macro-instructions may be created. In addition, all or part of the functionality of one or more of the support functions discussed herein in connection with FIG. 8 may be decomposed into multiple different support functions and/or may be combined with other functionality to create a different support function.

The run-time support functions illustrated in FIG. 8 perform code prefetch on the GPU (GPUInject( )), data prefetch on the GPU (GPUload( )), and execution of code on the GPU (GPUlaunch( )). FIG. 8 also illustrates a synchronization function (GPUWait( )) to be performed by the CPU. FIG. 8 also illustrates housekeeping (GPUrelease( ) and GPUfree( )) to be performed on the GPU.

The code-prefetch, data-prefetch and execute functions for the GPU may be implemented in the compiler as macro-instructions that are predefined for the CPU, rather than as general purpose runtime library function calls. They are abstracted to be functionally similar to well-established instructions and functions of the CPU. As a result, the compiler (see, e.g., 120 of FIGS. 1 and 3) appropriately generates and places prefetch instructions and performs other scheduling optimizations to effectively hide long hand-over latencies between the CPU and the GPU.

Thus, the compiler operates (see, e.g., block 408 of FIG. 4) on the source code 102 to generate CPU code 800 that includes one or more of the run-time support function calls. FIG. 4 illustrates, via pseudo-code, that the compiler generates, for two GPU-targeted code sequences, two run-time support functions (GPUlaunch( )) and also inserts optimizing run-time support function calls into the CPU code 800 such as load, pre-fetch, execute, and synchronization calls.

For the example pseudocode shown in FIG. 8, the first call to the GPUinject( ) function causes a download of the GPU code for macro-instruction GPU_foo_1 into the GPU, and the second call to the GPUinject( ) function causes a download of the GU code for macro-instruction GPU_foo_2 into the GPU. See 814. For at least one embodiment, this code injection to the memory of the GPU (see, e.g., 230 of FIGS. 2 and 9) may performed without additional CPU involvement (e.g., hardware DMA access). (See discussion of macro-instruction transport layer, below, in connection with FIG. 9). Thus, execution of the GPUinject( ) function by the CPU triggers GPU code prefetch operations. The function GPUload( ) manages the data transfer from and to the GPU. Execution of this function by the CPU triggers GPU data prefetch operation in the case of data loaded from the CPU to the GPU. See 816.

The function GPUlaunch( ) is executed by the CPU to cause the macro-instruction code to be executed by the GPU. For the example pseudo-code illustrated in FIG. 8, the first GPUlaunch( ) function 812 causes the GPU to begin execution of GPU_foo_l, while the second GPUlaunch( ) function 813 causes the GPU to begin execution of GPU_foo_2.

The function GPUwait( ) is used to sync back (join) the control flow for the CPU. That is, the GPUwait( ) function effects cross-processor communication to let the CPU know that the GPU has completed its work of executing the foreign macro-instruction indicated by a previous GPUlauch( ) function. The GPUwait( ) function may cause a stall on the CPU side. Such run-time support function may be inserted by the compiler in the CPU machine code, for example, when no further parallelism can be identified for the code 102 section, such that the CPU needs to results of the GPU operation before it can proceed with further processing.

The functions GPUrelease( ) and GPUfree( ) de-allocate the code and data areas on the GPU. These are housekeeping functions that free up GPU memory. The compiler may insert one or more of these run-time support functions into the CPU code at some point after a GPUInject( ) or GPUload( ) function, respectively, if it appears that the injected code and/or data will not be used in the near future. These housekeeping functions are optional and are not required for proper operation of embodiments of the heterogeneous pre-fetching techniques described herein.

While the runtime support function calls referred to above are presented as function calls, they are not treated by the compiler as general purpose library function calls. Instead, the compiler treats them as predefined CPU functions in terms of scheduling and optimizations that the compiler performs for these foreign operations. Thus, FIG. 8 illustrates that the compiler (see, e.g., 120 of FIG. 3) takes the code sequences that are indicated by the programmer (via pragma or other compiler directive; see, e.g., 810) in the source code 102 to be foreign code sequences for the GPU and compiles them as ‘foreign’ macro-instructions, creating for them prefetch function calls. In FIG. 8, such prefetch function calls include code prefetch calls 814 and data prefetch calls 816. In addition. FIG. 8 illustrates the other run-time support function calls that are inserted into the compiled CPU code 800 by the compiler. One of skill in the art will recognize that the compiled code 800 illustrated in FIG. 8 may be an intermediate representation of the source code 102. Based on the intermediate representation 800 that includes the run-time support function calls, the compiler may proceed to optimize the code 800 further, insert other CPU code among the macro-instruction calls as indicated by optimization algorithms, and otherwise provide for parallel execution of CPU-based instructions with the GPU macro-instructions.

For example, calls to GPLUload( )/GPUfree( ) may be subject to load-store optimizations by the compiler. Also for example, whole program optimization techniques in combination with detection of common code sequences can be used by the compiler to eliminate GPUinject( )/GPUrelease( ) pairs.

Also, for example, the compiler may employ interleaving of load and launch function calls to achieve desired scheduling effects. For example, the compiler may interleave the load and launch function calls 816, 812, 813 of FIG. 8 to further reduce latency. The GPU runtime scheduler (914 of FIG. 9) will not allow GPU processing corresponding to a CPU “launch” call to begin until any corresponding “inject” and “load” calls have completed execution on the GPU. Accordingly, the compiler 120 judiciously places the run-time support function calls into the code in a way that effects “scheduling” of the instructions to mask prefetch latency.

Another scheduling-related optimization that may be performed by the compiler is to utilize any multithreading capability of the GPU. As is illustrated in FIG. 8, multiple foreign code segments 852, 854 may be run concurrently on a GPU that has multiple thread contexts (either physical or logical) available. Accordingly, the compiler may “schedule” the code segments concurrently by placing the “launch” calls sequentially in the CPU code 800 without any synchronization instructions between them. It is assumed that the GPU runtime scheduler (914 of FIG. 9) will schedule the GPU operations corresponding to the “launch” calls in parallel, if feasible, on the GPU side.

To summarize, the compiler 102 (FIG. 3) described above thus may apply compiler optimization techniques to code written for a system that includes heterogeneous processor architectures to deliver optimized performance of foreign code. Foreign code portions, which are compiled for a processor architecture that is different from the CPU architecture, are compiled as foreign macro-instruction extensions to the native instruction set of the CPU. This compilation results in generation of prefetch and “launch” run-time function calls that are inserted into the intermediate representation for the foreign macro-instructions. Thus, the programmer need not use any special programming language (such as Prolog, Alice, MultiLisp, Act 1, etc) to effect synchronized concurrent programming for heterogeneous architectures. Instead, the modified compiler 102 discussed above may use any common programming language, such as C++, and implement the macro-instructions as extensions to the preferred language of the programmer. These extensions may be used by the programmer to effect concurrent programming on heterogeneous architectures that 1) does not require use of a specialized programming language such as those required for many implementations of futures and actor models, 2) does not require a standard library function call interface for foreign code calls, such as remote procedure calls or similar techniques, and 3) allows the extensions to undergo compiler optimization techniques along with other native CPU instructions. For one or more alternative embodiments, a compiler or pre-compilation tool automatically detects code sequences to be suitable for offloading to another processing element and implicitly inserts the appropriate markers into the source stream to indicate this to the subsequent compilation steps as if they where applied manually by the programmer. The scheme discussed above achieves the benefit of ease of programming that is not present with remote procedure calls, general library calls, or specialized programming languages. Instead, the selection of which code is to be compiled for CPU execution and which code is to be offloaded to the GPU for execution is indicated by pragma in a standard programming language, and the actual code calls to offload work to the GPU are created by the compiler and are not required to be manually inserted by the programmer. The compiler automatically generates macro-instructions that break up a foreign code sequence into load (pre-fetch), execute and store operations. These operations can then be optimized, along with native CPU instructions, with traditional compiler optimization techniques.

Such traditional compiler optimization techniques may include any techniques to help code run faster, use less memory, and/or use less power. Such optimizations may include loop, peephole, local, and/or intra-procedural (whole program) optimizations. For example, the compiler can employ compilation techniques that utilize loop optimizations, data-flow optimizations, or both, to effect efficient scheduling and code placement.

FIG. 9 illustrates at least one embodiment of a system 900 in which the run-time support function calls executed by the CPU 200 cause the appropriate operations to be performed on the GPU 220. FIG. 9 illustrates that the system 900 includes a modified compiler 120 (to generate heterogeneous machine code 908 for an application), a macro-instruction transport layer 904, and a foreign macro-instruction runtime system 906.

For at least one embodiment, the macro-instruction transport layer 904 may include a library 907 which includes GPU machine instructions to perform the required functionality to effectively inject the GPU code sequence (see, e.g., 820) corresponding to the macro-instruction 906 (see, e.g., 814 or 816) or load the data 909 into the GPU memory 230. The foreign macro-instruction transport layer library 907 may also provide the GPU machine language instructions for the functionality of the other run-time support functions such as “launch”, “release”, and “free” functions.

The macro-instruction transport layer 904 may be invoked, for example, when the CPU 200 executes a GPUinject( ) function call. This invocation results in code prefetch into the GPU memory system 230; this system 230 may include an on-chip code cache (not shown). Such operation provides that the proper code (see, e.g., 820 of FIG. 8) will be loaded into the GPU memory system 230. Without such GPUinject( ) call and its concomitant pre-fetching functionality, the GPU code may not be available for execution at the time it is needed. This pre-fetching operation for the GPU may be contrasted with the CPU 200, which already has all hardware and microcode necessary for native instruction execution available to it. Because many of these foreign macro-instructions may involve complex computations, a GPU code sequence (see, e.g., 820 of FIG. 8) may be generated by the compiler 120 and provided to the GPU 220 via the foreign macro-instruction transport layer 904 so that the GPU 220 can perform the proper sequence of GPU instructions corresponding to the GPUlaunch function call 906 that has been executed by the CPU 200.

For at least one embodiment, the foreign macro-instruction runtime system 906 runs on the GPU 220 to control execution of the various macro-instruction code injected by one or more CPU clients. The runtime may include a scheduler 914, which may apply its own caching and scheduling policies to effectively utilize the resources of the GPU 220 during execution of the foreign code sequence(s) 910.

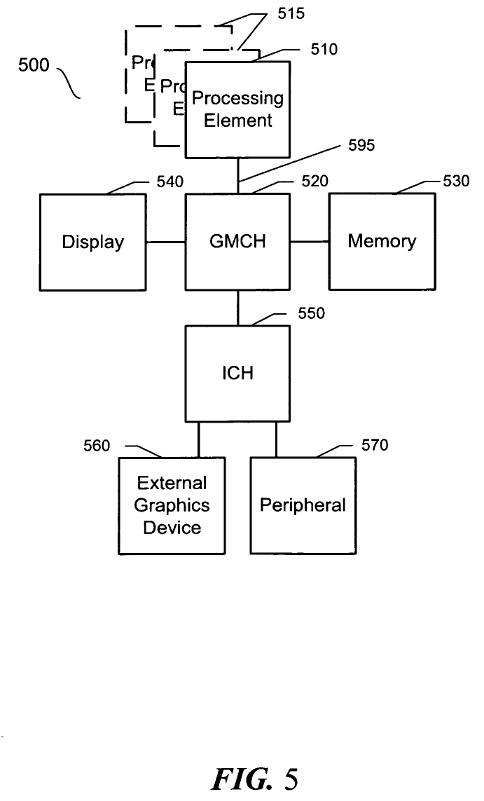

Embodiments may be implemented in many different system types. Referring now to FIG. 5, shown is a block diagram of a system 500 in accordance with one embodiment of the present invention. As shown in FIG. 5, the system 500 may include one or more processing elements 510, 515, which are coupled to graphics memory controller hub (GMCH) 520. The optional nature of additional processing elements 515 is denoted in FIG. 5 with broken lines. For at least one embodiment, the processing elements 510, 515 include heterogeneous processing elements, such as a CPU and a GPU, respectively.

Each processing element may include a single core or may, alternatively, include multiple cores. The processing elements may, optionally, include other on-die elements besides processing cores, such as integrated memory controller and/or integrated I/O control logic. Also, for at least one embodiment, the core(s) of the processing elements may be multithreaded in that they may include more than one hardware thread context per core.

FIG. 5 illustrates that the GMCH 520 may be coupled to a memory 530 that may be, for example, a dynamic random access memory (DRAM). For at least one embodiment, although illustrated as a single element in FIG. 5, the memory 530 may include multiple memory elements—one or more that are associated with CPU processing elements and one or more other memory elements that are associated with GPU processing elements (see, e.g., 210 and 230, respectively, of FIG. 2). The memory elements 530 may include instructions or code that comprise a micro-instruction transport layer (see, e.g., 904 of FIG. 9).

The GMCH 520 may be a chipset, or a portion of a chipset. The GMCH 520 may communicate with the processor(s) 510, 515 and control interaction between the processing element(s) 510, 515 and memory 530. The GMCH 520 may also act as an accelerated bus interface between the processing element(s) 510, 515 and other elements of the system 500. For at least one embodiment, the GMCH 520 communicates with the processing element(s) 510, 515 via a multi-drop bus, such as a frontside bus (FSB) 595.

Furthermore, GMCH 520 is coupled to a display 540 (such as a flat panel display). GMCH 520 may include an integrated graphics accelerator. GMCH 520 is further coupled to an input/output (I/O) controller hub (ICH) 550, which may be used to couple various peripheral devices to system 500. Shown for example in the embodiment of FIG. 5 is an external graphics device 560, which may be a discrete graphics device coupled to ICH 550, along with another peripheral device 570.

Alternatively, additional or different processing elements may also be present in the system 500. For example, additional processing element(s) 515 may include additional processors(s) that are the same as processor 510 and/or additional processor(s) that are heterogeneous or asymmetric to processor 510, such as accelerators (such as, e.g., graphics accelerators or digital signal processing (DSP) units), field programmable gate arrays, or any other processing element. There can be a variety of differences between the physical resources 510, 515 in terms of a spectrum of metrics of merit including architectural, microarchitectural, thermal, power consumption characteristics, and the like. These differences may effectively manifest themselves as asymmetry and heterogeneity amongst the processing elements 510, 515. For at least one embodiment, the various processing elements 510, 515 may reside in the same die package.

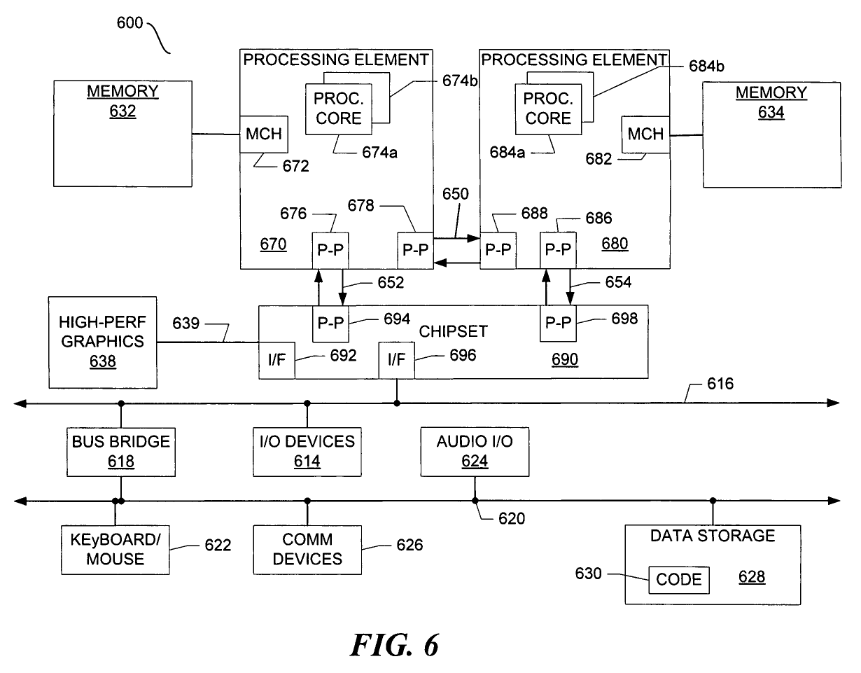

Referring now to FIG. 6, shown is a block diagram of a second system embodiment 600 in accordance with an embodiment of the present invention. As shown in FIG. 6, multiprocessor system 600 is a point-to-point interconnect system, and includes a first processing element 670 and a second processing element 680 coupled via a point-to-point interconnect 650. As shown in FIG. 6, each of processing elements 670 and 680 may be multicore processing elements, including first and second processor cores (i.e., processor cores 674a and 674b and processor cores 684a and 684b).

One or more of processing elements 670, 680 may be an element other than a CPU, such as a graphics processor, an accelerator or a field programmable gate array. For example, one of the processing elements 670 may be a single- or multi-core general purpose processor while another processing element 680 may be a single- or multi-core graphics accelerator, DSP, or co-processor.

While shown in FIG. 6 with only two processing elements 670, 680, it is to be understood that the scope of the present invention is not so limited. In other embodiments, one or more additional processing elements may be present in a given processor.

First processing element 670 may further include a memory controller hub (MCH) 672 and point-to-point (P-P) interfaces 676 and 678. Similarly, second processing element 680 may include a MCH 682 and P-P interfaces 686 and 688. As shown in FIG. 6, MCH's 672 and 682 couple the processors to respective memories, namely a memory 632 and a memory 634, which may be portions of main memory locally attached to the respective processors.

First processing element 670 and second processing element 680 may be coupled to a chipset 690 via P-P interconnects 676, 686 and 684, respectively. As shown in FIG. 6, chipset 690 includes P-P interfaces 694 and 698. Furthermore, chipset 690 includes an interface 692 to couple chipset 690 with a high performance graphics engine 638. In one embodiment, bus 639 may be used to couple graphics engine 638 to chipset 690. Alternately, a point-to-point interconnect 639 may couple these components.

In turn, chipset 690 may be coupled to a first bus 616 via an interface 696. In one embodiment, first bus 616 may be a Peripheral Component Interconnect (PCI) bus, or a bus such as a PCI Express bus or another third generation I/O interconnect bus, although the scope of the present invention is not so limited.

As shown in FIG. 6, various I/O devices 614 may be coupled to first bus 616, along with a bus bridge 618 which couples first bus 616 to a second bus 620. In one embodiment, second bus 620 may be a low pin count (LPC) bus. Various devices may be coupled to second bus 620 including, for example, a keyboard/mouse 622, communication devices 626 and a data storage unit 628 such as a disk drive or other mass storage device which may include code 630, in one embodiment. The code 630 may include instructions for performing embodiments of one or more of the methods described above. Further, an audio I/O 624 may be coupled to second bus 620. Note that other architectures are possible. For example, instead of the point-to-point architecture of FIG. 6, a system may implement a multi-drop bus or another such architecture.

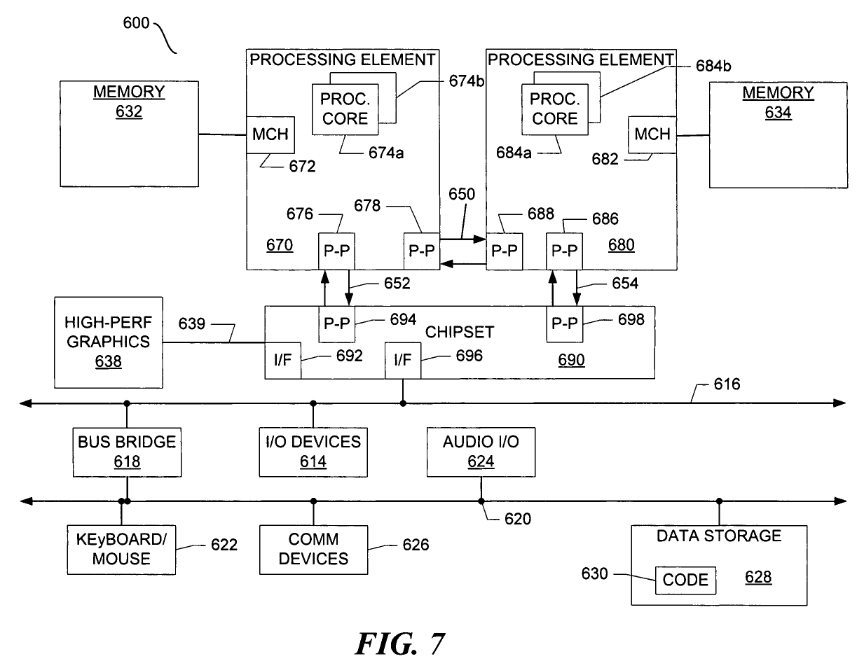

Referring now to FIG. 7, shown is a block diagram of a third system embodiment 700 in accordance with an embodiment of the present invention. Like elements in FIGS. 6 and 7 bear like reference numerals, and certain aspects of FIG. 6 have been omitted from FIG. 7 in order to avoid obscuring other aspects of FIG. 7.

FIG. 7 illustrates that the processing elements 670, 680 may include integrated memory and I/O control logic (“CL”) 672 and 682, respectively. While illustrated for both processing elements 670, and 680, one should bear in mind that the processing system 700 may be heterogeneous in the sense that one or more processing elements 670 may have integrated CL logic while one or more others 680 does not.

For at least one embodiment, the CL 672, 682 may include memory controller hub logic (MCH) such as that described above in connection with FIGS. 5 and 6. In addition. CL 672, 682 may also include I/O control logic. FIG. 7 illustrates that not only are the memories 632, 634 coupled to the CL 672, 682, but also that I/O devices 714 are also coupled to the control logic 672, 682. Legacy I/O devices 715 are coupled to the chipset 690.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device.

Program code, such as code 630 illustrated in FIG. 6, may be applied to input data to perform the functions described herein and generate output information. For example, program code 630 may include a heterogeneous optimizing compiler that is coded to perform embodiments of the method 400 illustrated in FIG. 4. Alternatively, or in addition, program code 630 may include compiled heterogeneous machine code such as that 800 illustrated for the example presented in FIG. 8 and shown as 908 in FIG. 9. Accordingly, embodiments of the invention also include machine-accessible media containing instructions for performing the operations of the invention or containing design data, such as HDL, which defines structures, circuits, apparatuses, processors and/or system features described herein. Such embodiments may also be referred to as program products.

Such machine-accessible storage media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language.

Presented herein are embodiments of methods and systems for compiling code for a heterogeneous system that includes both one or more primary processors and one or more parallel co-processors. For at least one embodiment, the primary processors(s) include a CPU and the parallel co-processor(s) include a GPU. An optimizing compiler for the heterogeneous system comprehends the architecture of both processors, and generates an optimized fat binary that includes machine code instructions for both the primary processor(s) and the co-processor(s); the fat binary is generated without the aid of remote procedure calls for foreign code sequences (referred to herein as “macro-instructions”) to be executed on the GPU. The binary is the result of compiler optimization techniques, and includes prefetch instructions to load code and/or data into the GPU memory concurrently with execution of other instructions on the CPU. While particular embodiments of the present invention have been shown and described, it will be obvious to those skilled in the art that numerous changes, variations and modifications can be made without departing from the scope of the appended claims. Accordingly, one of skill in the art will recognize that changes and modifications can be made without departing from the present invention in its broader aspects. The appended claims are to encompass within their scope all such changes, variations, and modifications that fall within the true scope and spirit of the present invention.

What is claimed is:

1. A method comprising:
generating in an intermediate code representation a prefetch instruction and a launch instruction corresponding to an instruction, in a source program, that indicates an operation to be performed on a second processor; and
performing one or more compiler optimizations on the intermediate code representation to generate a binary file, the binary file including first machine instructions of the target processor for the prefetch instruction and the launch instruction and at least one other instruction, as well including one or more second machine instructions of the second processor to be executed by the second processor responsive to the target processor's execution of the launch instruction,
the binary file further being structured so that the at least one other instruction is to be executed on the target processor while the second processor executes the second machine instructions.

2. The method of claim 1, wherein:
said prefetch instruction is a data prefetch instruction.

3. The method of claim 1, wherein:
said prefetch instruction is a code prefetch instruction.

4. The method of claim 1, wherein said binary is structured such that one or more instructions are to be executed on the target processor concurrent with the second processor's execution of processing associated with the prefetch instruction.

5. The method of claim 1, wherein:
said binary is structured such that the second machine instructions represent operations to be offloaded to the second processor and executed concurrently with the at least one other instruction to be executed on the first processor.

6. The method of claim 1, wherein:
said binary is structured such that said second machine instructions are interleaved with said first machine instructions.

7. The method of claim 1, wherein said instruction in said source program is a compiler directive.

8. The method of claim 7, wherein said compiler directive is a pragma statement.

9. A system comprising:
a die package that includes a first processor and a second processor, said first and second processors being heterogeneous with respect to each other;
a first memory coupled to said first processor and a second memory coupled to said second processor;
a library to facilitate transport of instructions and data, related to a set of source instructions, between the first processor and the second memory, wherein said second memory is not shared by said first processor;
said first and second processors to execute a single executable code image that has been compiled by an optimizing compiler such that the executable image includes one or more calls to the library to trigger transport of data for the set of source instructions to the second processor while the first processor concurrently executes one or more other instructions.

10. The system of claim 9, wherein:
the second processor is capable of concurrent execution of multiple threads.

11. The system of claim 9, wherein said first memory is a DRAM.

12. The system of claim 9, wherein the first processor is a central processing unit.

13. The system of claim 12, further comprising one or more additional central processing units.

14. The system of claim 9, wherein the second processor is a graphics processing unit.

15. The system of claim 14, wherein the graphics processing unit is to execute multiple threads concurrently.

16. The system of claim 9, wherein the library is stored in the second memory.

17. The system of claim 9, wherein the transported data is source data for the set of source instructions.

18. The system of claim 9, wherein the transported data is machine code instructions of the second processor that are to cause the second processor to perform one or more operations corresponding to the source set of instructions.

19. An article comprising a machine-accessible medium including instructions that when executed cause a system to:
generate in an intermediate code representation a prefetch instruction and a launch instruction corresponding to an instruction, in a source program, that indicates one or more instructions to be performed on a second processor;
wherein said launch instruction is to be executed as a predefined function of a target processor rather than as a remote procedure call; and
perform one or more compiler optimizations on the intermediate code representation to generate a binary file, the binary file including first machine instructions of the target processor for the prefetch instruction and the launch instruction and at least one other instruction, as well including one or more second machine instructions of the second processor to be executed by the second processor responsive to the target processor's execution of the launch instruction, the binary file further being structured so that the at least one other instruction is to be executed on the target processor concurrent with the second processor's execution of the second machine instructions.

20. The article of claim 19, wherein said prefetch instruction is a data prefetch instruction.

21. The article of claim 19, wherein said prefetch instruction is a code prefetch instruction.

22. The article of claim 19, further comprising instructions that when executed enable the system to construct said binary such that one or more instructions are to be executed on the target processor while the second processor executes processing associated with the prefetch instruction.

23. The article of claim 19, wherein said instruction in said source program is a compiler directive.

24. The article of claim 19, wherein said instruction in said source program is a pragma statement.

25. The article of claim 19, wherein:
said binary is structured such that the second machine instructions represent operations to be offloaded to the second processor and executed concurrently with the at least one other instruction to be executed on the first processor.

26. The article of claim 19, wherein:
said binary is structured such that said second machine instructions are interleaved with said first machine instructions.
